(19) United States
(12) Patent Application Publication
(10) Pub. No.: US 2009/0146448 A1
(43) Pub. Date: Jun. 11, 2009

(54) Motor Vehicle

(75) Inventor: Peter Hofmann, Neuhausen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AG, Weissach (DE)

(21) Appl. No.: 12/330,015

(22) Filed: Dec. 8, 2008

(30) Foreign Application Priority Data
Dec. 8, 2007 (DE) 10 2007 059 209.6

(51) Int. Cl. B60J 3/02

(52) U.S. Cl. 296/97.4

(57) ABSTRACT

A motor vehicle has a protective device which is arranged behind a backrest of a motor vehicle seat and has a flexible plane surface structure, in particular a sun blind, adjustable between an extended position of use and a retracted inoperative position. Accordingly, the motor vehicle is of coupe-like design and an electrical drive device is provided, which adjusts the flexible plane surface structure in the form of a sun blind between its position of use and its inoperative position substantially vertically, the sun blind in its position of use being arranged so that it is substantially vertically free-standing.

### CROSS-REFERENCE TO RELATED APPLICATION

This application claims the priority, under 35 U.S.C. § 119, of German application DE 10 2007 059 209.6, filed Dec. 8, 2007; the prior application is herewith incorporated by reference in its entirety.

### BACKGROUND OF THE INVENTION

1. Field of the Invention:

The present invention relates to a motor vehicle having a protective device arranged behind a backrest of a motor vehicle seat.

Published, non-prosecuted German patent application DE 10 2004 055 359 A1 discloses a protective device for motor vehicles, which has a flexible plane surface structure, in particular a sun blind, adjustable between a position of use and an inoperative position. A manual operating element, which together with a device for transmission forms a mechanical transmission chain, so that a movement of the operating element can be translated into a retracting or extending movement of the flexible plane surface structure, serves to adjust the flexible plane surface structure between its position of use and its inoperative position. The protective device is preferably here used to separate a load space from a passenger compartment in a motor vehicle. Extension is here always performed by a manually operated mechanical device, although electrically assisted retracting and extending movements are feasible.

European patent EP 0 240 747 B1, corresponding to U.S. Pat. No. 4,836,263, discloses an extendible window blind, which can be adjusted between an extended position of use and a retracted inoperative position by means of a complicated lever mechanism.

### SUMMARY OF THE INVENTION

It is accordingly an object of the invention to provide a motor vehicle that overcomes the above-mentioned disadvantages of the prior art devices of this general type, which will, in particular, reliably prevent unwanted insolation into a passenger compartment through a rear screen and in which a protective device is beneficially configured and arranged to obstruct the insolation

With the foregoing and other objects in view there is provided, in accordance with the invention, a coupe-like motor vehicle. The coupe-like motor vehicle contains a seat having a backrest and a protective device disposed behind the backrest and having a flexible plane surface structure, being a sun blind, adjustable between an extended position of use and a retracted inoperative position. An electrical drive device is provided for adjusting the flexible plane surface structure being the sun blind between the extended position of use and the retracted inoperative position. The sun blind in the extended position of use is disposed so that the sun blind is substantially vertically free-standing.

The general idea behind the invention in a motor vehicle of a coupe type, which usually has a sharply inclined rear screen or window, is to arrange a corresponding protective device for protection against incident solar radiation through the rear screen behind a backrest of a motor vehicle seat and to equip it with an electrical drive device, which adjusts a flexible plane surface structure in the form of a sun blind substantially vertically between its extended position of use and its retracted inoperative position. In contrast to existing sun blinds known in the prior art, the sun blind according to the invention is moreover vertically freestanding in its position of use, that is to say it is not connected by an upper end area to a vehicle body, and in particular not connected to an inside roof lining. In contrast to the sun blinds known in the state of the art, the protective device according to the invention has a relatively small extending travel, which is distinctly shorter than in the case of a sun blind arranged directly under a rear screen, which would then have to be adjusted parallel to and along the rear screen. Reducing the extending height at the same time also reduces the weight of the protective device, which is of great advantage especially in sports car construction. Arranging the protective device according to the invention directly behind the backrests of the motor vehicle seats furthermore affords the advantage that the protective device is not fixed to a tailgate and thereby does not constitute an additional weight that has to be braced by gas-filled springs, for example, when opening the tailgate. At the same time the protective device does not have any great acceleration forces acting thereon, as would be the case if the protective device were arranged fixed to the tailgate. Arranging the protective device behind the backrests of the motor vehicle seats also allows the protective device to be detachably fixed in the motor vehicle, which means that, if necessary, it can be removed from the vehicle. If it were arranged on the tailgate, a detachable arrangement would not be readily feasible.

The protective device is suitably arranged in a housing, which also accommodates a load space cover with an extending blind. This affords the advantage that the protective device is arranged together with the load space cover in a type of cassette and can thereby be of extremely compact design. This is also advantageous when removing the protective device, since by removing the housing both the protective device and the load space cover can be removed together, thereby enlarging the load space.

In an advantageous development of the invention the protective device extends in the vehicle transverse direction and at its longitudinal ends is held in corresponding vehicle-side mountings, which are configured and arranged so that the protective device can be fitted working from a passenger compartment. The protective device can therefore be removed from the vehicle, depending on the embodiment together with or without the load space cover and can therefore easily be removed from the vehicle in order to enlarge a load space volume situated behind the vehicle seats, in particular behind the rear seats. The scope for fitting and removing the protective device working from the passenger compartment moreover makes it much easier to fit and remove than is the case when fitting or removing from the trunk. The vehicle-side mountings can here be configured so that when introducing the longitudinal ends of the protective device they hold these ends securely in the vehicle-side mountings, for example by fixing elements.

In a further advantageous embodiment of the invention the protective device has a gap cover, which is pre-tensioned towards a backrest and covers a gap between the backrest and the protective device. Where the protective device is arranged directly behind the vehicle seats, a gap cover could usually be dispensed with, whereas in the case of motor vehicle seats, especially rear seats with adjustable backrests, depending on the position of the backrests a gap remains between the backrest and the protective device, which can then be covered by the gap cover according to the invention, thereby giving a closed outward appearance. Spring tensioning of the gap cover towards the backrests moreover means that gap can be reliably covered irrespective of the position of the backrest. Besides the closed outward appearance, the gap cover also shields cargo stowed under the protective device from view and protects it from dirt.

It will be obvious that the features specified above and yet to be explained below may be used not only in the particular combination specified but also in other combinations or alone, without departing from the scope of the present invention.

Other features which are considered as characteristic for the invention are set forth in the appended claims.

Although the invention is illustrated and described herein as embodied in a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal section view through a rear part of a motor vehicle having a protective device according to the invention;

FIG. 2 is a diagrammatic, perspective view of a rear body area of the motor vehicle having the protective device installed; and

FIG. 3 is a diagrammatic, perspective view of the protective device.

### DETAILED DESCRIPTION OF THE INVENTION

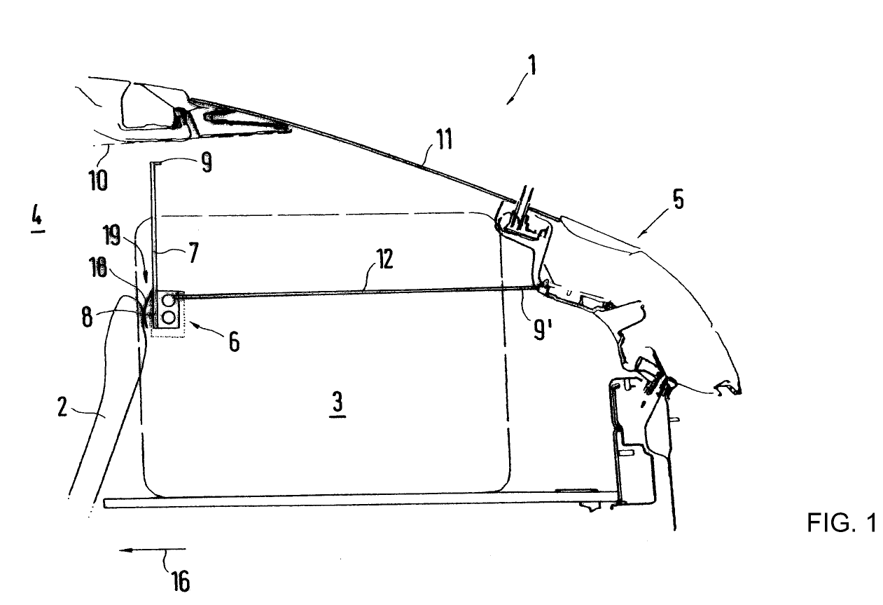

Referring now to the figures of the drawing in detail and first, particularly, to FIG. 1 thereof, there is shown a motor vehicle 1 (only partially represented) that has a load space 3 situated behind a backrest 2 of a motor vehicle seat, otherwise not represented. The backrest 2 may here belong to a rear seat of the motor vehicle 1. The load space 3 is preferably accessible both from a passenger compartment 4 and also by opening a tailgate or rear hood 5. Arranged immediately behind the backrest 2 is a protective device 6, which has a flexible plane surface structure 7, adjustable between an extended position of use (see FIGS. 1 to 3) and a retracted inoperative position. In FIGS. 1 to 3 the plane surface structure 7 is shown in its extended position of use, whereas in its inoperative position it is accommodated wound up in a housing 8 of the protective device 6.

According to the invention the plane surface structure 7 is embodied as a sun blind and by use of a non-illustrated electrical drive device is adjustable between a position of use and an inoperative position. As can here be seen from FIG. 1, the plane surface structure 7 is adjustable between its position of use and its inoperative position in a substantially vertical direction and in its position of use is arranged substantially vertically freestanding. In this context the term ‘arranged freestanding’ means that the flexible plane surface structure 7 is not connected by an upper end area 9 to the motor vehicle 1, and in particular is not connected to an inside roof lining 10 of the motor vehicle 1.

The substantially vertically adjustable plane surface structure 7 of the protective device 6 here affords the great advantage that the protective device 6 reliably keeps the incident solar radiation through a rear screen 11 off the passenger compartment 4. In particular, the protective device 6 according to the invention has a significantly smaller extending height to cover the rear screen 11 than would be the case with a protective device arranged directly under the rear screen 11, in which the sun blind would then have to be adjusted parallel to and along the rear screen 11. Owing to the smaller area of fabric, the smaller extending height affords a weight advantage, which is of particular importance in sports car construction.

Compared to protective devices arranged under the rear screen 11, that is to say directly against the tailgate 5, with the protective device 6 arranged according to the invention, the tailgate 5 remains unburdened by the weight of the protective device 6, so that the gas-filled springs assisting an opening movement of the tailgate 5 do not also have to brace the weight of the protective device 6 and therefore do not have to be of stronger construction. At the same time the protective device 6 arranged according to the invention is also not exposed to the high acceleration forces, as would be the case if the protective device 6 were arranged immediately under the rear screen 11 against the tailgate 5. The high acceleration forces would here in the latter case act on the protective device 6 particularly when slamming the tailgate 5 shut, so that the device would have to be connected especially firmly to the tailgate 5. As can further be seen from FIG. 1, a load space cover with an extendable blind 12, which in an extended state covers the load space 3, is also arranged in the housing 8 of the protective device 6. The blind 12 can here be adjusted manually or also by an electrical drive between an inoperative position retracted into the housing 8 and a position of use represented in FIG. 1. In order to make the load space 3 accessible despite the blind 12 being in its position of use, an end area 9′ of the blind 12 is preferably fixed to the tailgate 5 of the coupe-like motor vehicle 1, so that when opening the tailgate 5 the end area 9′ of the blind 12 is also raised and automatically affords access to the load space 3.

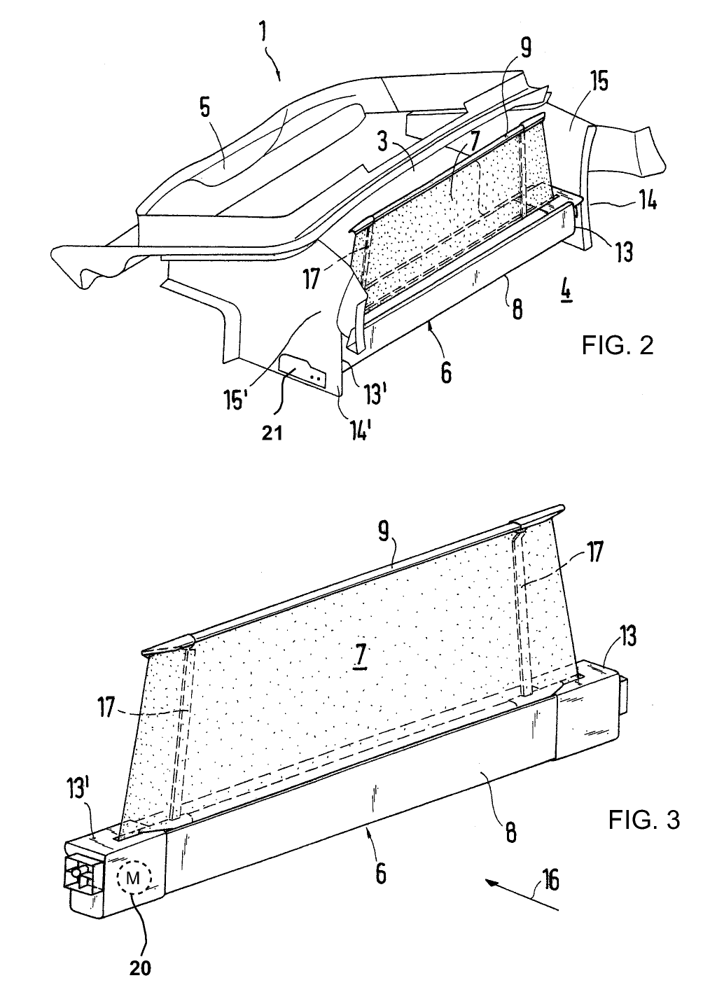

As is shown in FIGS. 2 and 3, the protective device 6 extends substantially in the vehicle transverse direction and at its longitudinal ends 13 and 13′ is held in corresponding vehicle-side mountings 14, 14′, which are configured and arranged so that the protective device 6 can be fitted working from the passenger compartment 4, which makes it much easier to fit and remove than the protective device 6.

As can be seen in particular from FIG. 2, the vehicle-side mountings 14 and 14′ are arranged in an area of a C-pillar 15 and 15′ of the motor vehicle 1 and hence directly behind the backrests 2 of the rear seats. Since the protective device 6 according to the invention has an aforementioned electrical drive device 20, which is arranged in one of the longitudinal end areas 13, 13′, for example, for adjusting the plane surface structure 7 between its position of use and its inoperative position, an electrical contact device 21, via which the electrical drive device 20 can be connected to a vehicle electrical system of the motor vehicle 1, is provided in the area of at least one of the two vehicle-side mountings 14, 14′. In addition, non-illustrated catch elements, which are preferably pre-tensioned by springs and which interact with corresponding detent elements or catch openings in the vehicle-side mountings 14, 14′, thereby reliably holding the longitudinal ends 13, 13′ in the respectively associated vehicle-side mountings 14, 14′, may be provided, at least at one longitudinal end 13, 13′ of the protective device 6.

For stretching the plane surface structure 7, which is on the one hand impervious to insolation but on the other of a visually transparent configuration, an adjustable tensioning linkage 17, which is situated behind the plane surface structure 7 in the direction of travel, i.e. behind the sun blind, is provided, and being of adjustable design holds the flexible plane surface structure 7 in a tensioned state, especially in its position of use. The tensioning linkage 17 is here configured so that when the plane surface structure 7 is fully in its inoperative position the linkage extends parallel to the longitudinal extent of the protective device 6 and is accommodated inside the housing 8 of the protective device 6. Under the extending movement the tensioning linkage 17 slowly straightens up, thereby tensioning the plane surface structure 7, which can additionally be tensioned by way of a spring-loaded winding shaft in the housing 8.

Returning to FIG. 1, it must also be mentioned that a gap cover 18, which is pre-tensioned towards the backrest 2 and is thereby capable of covering a gap 19 between the backrest 2 and the protective device 6, may be provided on the protective device 6. Such a gap 19 adversely affects the outward appearance, especially in the case of adjustable backrests 2, and should therefore be covered by the gap cover 18 in all conceivable positions of the backrest 2. For the sake of simplicity, the gap cover 18 is not represented in FIGS. 2 and 3.

Arranging the protective device 6 directly behind the backrest 2 of the rear seats means that in contrast to fitting on the tailgate 5 it can be of a detachable configuration and easily fitted and removed working from the passenger compartment 4, especially in order to enlarge the load space 3. The electrical drive device moreover allows a comfortable adjustment of the sun blind, that is to say the plane surface structure 7, from its position of use into its inoperative position or vice versa.

1. A coupe-like motor vehicle, comprising:
a seat having a backrest;
a protective device disposed behind said backrest and having a flexible plane surface structure, being a sun blind, adjustable between an extended position of use and a retracted inoperative position; and
an electrical drive device for adjusting said flexible plane surface structure being said sun blind between the extended position of use and the retracted inoperative position, said sun blind in the extended position of use being disposed so that said sun blind is substantially vertically free-standing.

2. The coupe-like motor vehicle according to claim 1, further comprising:
a housing, said protective device is disposed in said housing; and
a load space cover having an extendible blind is disposed in said housing.

3. The coupe-like motor vehicle according to claim 2, further comprising a tailgate and said extendible blind of said load space cover can be fixed to said tailgate.

4. The coupe-like motor vehicle according to claim 1,
further comprising corresponding vehicle-side mountings; and
wherein said protective device extends in a vehicle transverse direction and has longitudinal ends engaging in said corresponding vehicle-side mountings.

5. The coupe-like motor vehicle according to claim 4, wherein said vehicle-side mountings are configured and disposed such that it is possible to fit said protective device working from a passenger compartment of the coupe-like motor vehicle.

6. The coupe-like motor vehicle according to claim 4, further comprising a C-pillar and said vehicle-side mountings are disposed in an area of said C-pillar.

7. The coupe-like motor vehicle according to claim 4, further comprising
a vehicle electric system; and
an electrical contact device, via which said electrical drive device is connected to said vehicle electrical system, is disposed in an area of at least one of said vehicle-side mountings.

8. The coupe-like motor vehicle according to claim 4,
wherein said protective device has longitudinal ends;
wherein said vehicle-side mountings have one of detent elements and catch openings formed therein; and
further comprising catch elements, which interact with said detent elements or said catch openings in said vehicle-side mountings, disposed at least at one of said longitudinal ends of said protective device.

9. The coupe-like motor vehicle according to claim 1, wherein said protective device has a gap cover, which is pre-tensioned towards said backrest and covers a gap between said backrest and said protective device.

10. The coupe-like motor vehicle according to claim 1, further comprising an adjustable tensioning linkage disposed behind said sun blind in a direction of travel and which holds said sun blind in a tensioned state, especially in the extended position of use.
